(19) United States
(12) Patent Application Publication
(10) Pub. No.: US 2006/0000650 A1
(43) Pub. Date: Jan. 5, 2006

(54) Hybrid vehicle conversion kit

(76) Inventor: Charles E. Hughey, Granger, IN (US)

Correspondence Address: BAKER & DANIELS LLP, 300 NORTH MERIDIAN STREET, SUITE 2700, INDIANAPOLIS, IN, 46204, US

(21) Appl. No.: 11/159,839

(22) Filed: Jun. 23, 2005

Related U.S. Application Data
(60) Provisional application No. 60/582,101, filed on Jun. 23, 2004.

(51) Int. Cl. B60K 1/00

(52) U.S. Cl. 180/65.2

(57) ABSTRACT

This disclosure relates to a hybrid electrical drive system for a vehicle, and in particular, to a conversion kit for converting a vehicle with a standard internal combustion engine into a hybrid electrical vehicle. The conversion kit is designed to increase the fuel efficiency and travel range of the vehicle so converted, and to provide additional horse power upon acceleration. The system utilizes a novel arrangement to intercept kinetic energy that would normally be wasted as the vehicle is decelerating or braking. The system converts the kinetic energy to electrical energy to recharge an on board electrical energy supply source for use in assisting with the acceleration of the vehicle.

### BACKGROUND OF THE INVENTION

This application claims the benefit of U.S. Provisional Patent Application Ser. No. 60/582,101 filed Jun. 23, 2004, the complete disclosure of which is hereby expressly incorporated by reference.

This invention relates to a hybrid electrical drive system for a vehicle, and in particular, to a conversion kit for converting a vehicle with a standard internal combustion engine into a hybrid electrical vehicle. The conversion kit is designed to increase the fuel efficiency and travel range of the vehicle so converted, and to provide additional horse power upon acceleration. The system utilizes a novel arrangement to intercept kinetic energy that would normally be wasted as the vehicle is decelerating or braking. The system converts the kinetic energy to electrical energy to recharge an on board electrical energy supply source for use in assisting with the acceleration of the vehicle.

In an effort to conserve resources and reduce environmental impact, a growing effort has been made to produce electrical vehicles or hybrid electrical vehicles, which use a combination of electric power and an alternate power source, such as an internal combustion engine. A challenge has always been how to provide increased range and power of a hybrid vehicle to reduce the frequency of stops required for refueling the internal combustion engine or to recharge the energy storage system from an external energy source.

It is well known to provide both AC and DC drive motors on an electrical vehicle. Furthermore, one method that is well known for trying to increase the range of an electrical vehicle or a hybrid electrical/internal combustion vehicle is to provide a regenerative braking system. A regenerative braking system captures a portion of the kinetic energy in a vehicle during deceleration. As the vehicle is decelerating, the electric motor of an electric vehicle may be used to provide a kinetic braking force and is operated as a generator used to generate electrical energy to recharge the energy storage system. Of course, a separate motor/generator may also be used to provide the braking force as is common in a hybrid vehicle. The electrical energy produced by the regenerative system is stored in an energy storage system and is used to power the vehicle's electric motor to increase the range of the vehicle. Examples of regenerative braking systems are found in U.S. Pat. No. 6,033,041 to Koga, et al.; U.S. Pat. No. 6,222,334 to Tamagawa, et al.; U.S. Pat. No. 6,490,511 to Raftari, et al.; U.S. Pat. No. 6,497,635 to Suzuki; and U.S. Pat. No. 6,518,732 to Palanisami, all of which are fully incorporated herein by reference.

Although the rate of sales has been increasing greatly in recent years for hybrid vehicles, hybrid vehicles still only account for a mere fraction of new vehicle sales. One reason for this is that there is a significant premium on the price for hybrid vehicles that tends to far exceed the fuel cost and any tax savings that may be achieved with the hybrid vehicle. Furthermore, there is not currently any aftermarket conversion available for converting a standard internal combustion engine into a hybrid vehicle.

It is, therefore, an object of the invention to provide a kit for use in converting a standard internal combustion engine into a hybrid vehicle that includes a regenerative braking and electrical power assist motor/generator to increase the fuel efficiency of internal combustion vehicles. It is a further object of the invention to provide the conversion kit in an economical manner that will allow the owner to realize a savings in the operation of the vehicle.

### SUMMARY OF THE INVENTION

It is a feature of the invention to provide a conversion kit for use in converting a vehicle having a standard internal combustion engine into a hybrid electrical vehicle. In one embodiment, the invention includes a DC electric motor/generator, a controller, and an electrical energy supply source. During deceleration periods, the electric motor/generator recharges the electrical energy supply source, which may be a battery or a battery array, and during period of acceleration, the controller controls the battery array to provide electrical energy to drive the electric motor and assist the internal combustion engine in accelerating the vehicle. In one embodiment, the electric motor/generator assembly is mounted on an output shaft attached to the transmission of the vehicle.

### BRIEF DESCRIPTION OF THE DRAWINGS

The above-mentioned and other features and objects of this invention and the manner of obtaining them will become more apparent and the invention itself will be better understood by reference to the following description of an embodiment of the present invention taken in conjunction with the accompanying drawings, wherein:

FIG. 1 is a schematic diagram of a vehicle retrofitted with a hybrid conversion kit of the present invention;

FIG. 2 is a perspective view of a typical transmission output shaft and housing with a portion of the housing cut away;

FIG. 3 is a perspective view of a DC electric motor/generator and housing of the hybrid conversion kit shown with a portion of the housing cut away and installed on a transmission output shaft;

FIG. 4 is a side view of a typical prior art drive assembly including a transmission, an output shaft, an output extension housing and a drive shaft for a rear wheel drive vehicle;

FIG. 5 is a side view of the drive assembly of FIG. 4 with the output, extension housing, and drive shaft removed from the transmission output shaft;

FIG. 6 is a side view of the drive assembly of FIG. 4 with the DC electric motor/generator of the hybrid conversion kit being installed to replace the standard output extension housing with a portion of the housing of the DC electric motor/generator cut away; and

FIG. 7 is a side view of the drive assembly shown in FIG. 6 with the DC motor/generator and drive shaft installed on the transmission to convert the vehicle into a hybrid.

Corresponding reference characters indicate corresponding parts throughout the several views. Although the drawings represent embodiments of the present invention, the drawings are not necessarily to scale and certain features may be exaggerated in order to better illustrate and explain the present invention. The exemplification set out herein illustrates an embodiment of the invention, in one form, and such exemplifications are not to be construed as limiting the scope of the invention in any manner.

### DETAILED DESCRIPTION OF EMBODIMENTS OF THE INVENTION

For the purposes of promoting an understanding of the principles of the invention, reference will now be made to the embodiments illustrated in the drawings and specific language will be used to describe the same. It will nevertheless be understood that no limitation of the scope of the invention is thereby intended. The invention includes any alterations and further modifications in the illustrated devices and described methods and further applications of the principles of the invention which would normally occur to one skilled in the art to which the invention relates.

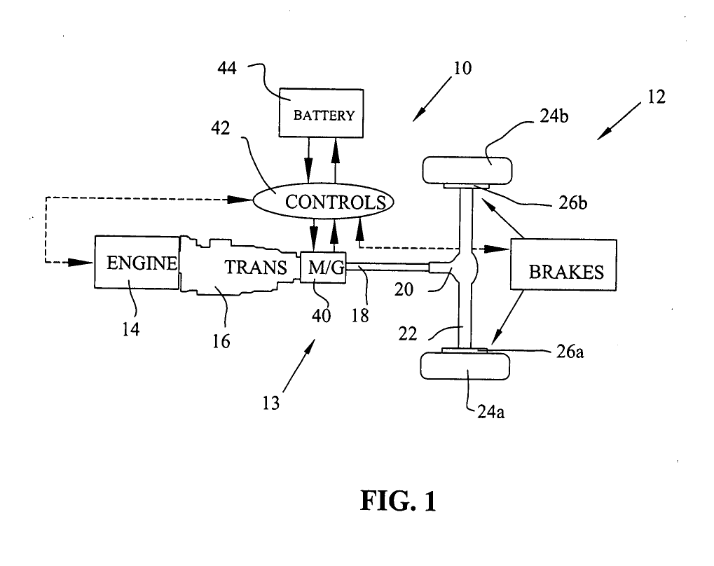

Referring now to FIG. 1, a hybrid conversion kit generally indicated as 10 is shown installed on a vehicle generally indicated as 12. In the embodiment shown, vehicle 12 is a rear-wheel drive vehicle and includes a drive assembly 13; an internal combustion engine 14, such as a gasoline or diesel engine as is well known; a transmission, which may be of a known manual or automatic version; and a drive shaft 18 driven by the transmission 16. Vehicle 12 also includes a differential 20 connected to the transmission, a rear axle 22 extending outwardly from the differential and generally perpendicular to the drive shaft, and a pair of rear wheels/tires 24a, 24b. Drive assembly 13 also includes a pair of conventional rear brakes 26a, 26b mounted to rear wheels 24a, 24b, respectively. It should be noted that besides the components included in hybrid conversion kit 10, vehicle 12 and drive assembly 13 are typical for a standard internal combustion rear-wheel drive vehicle.

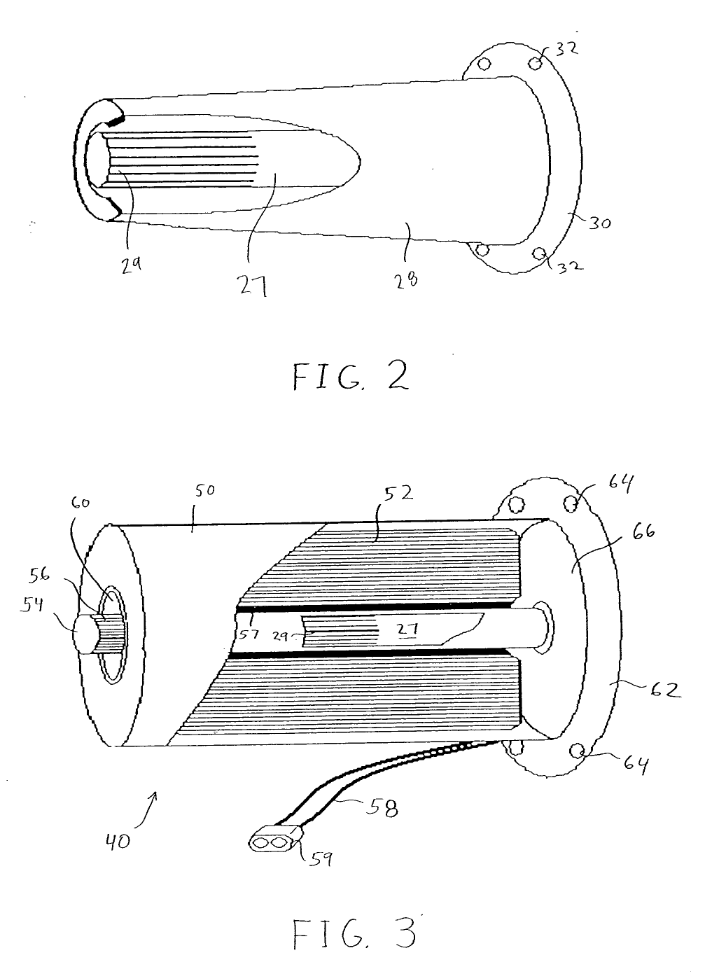

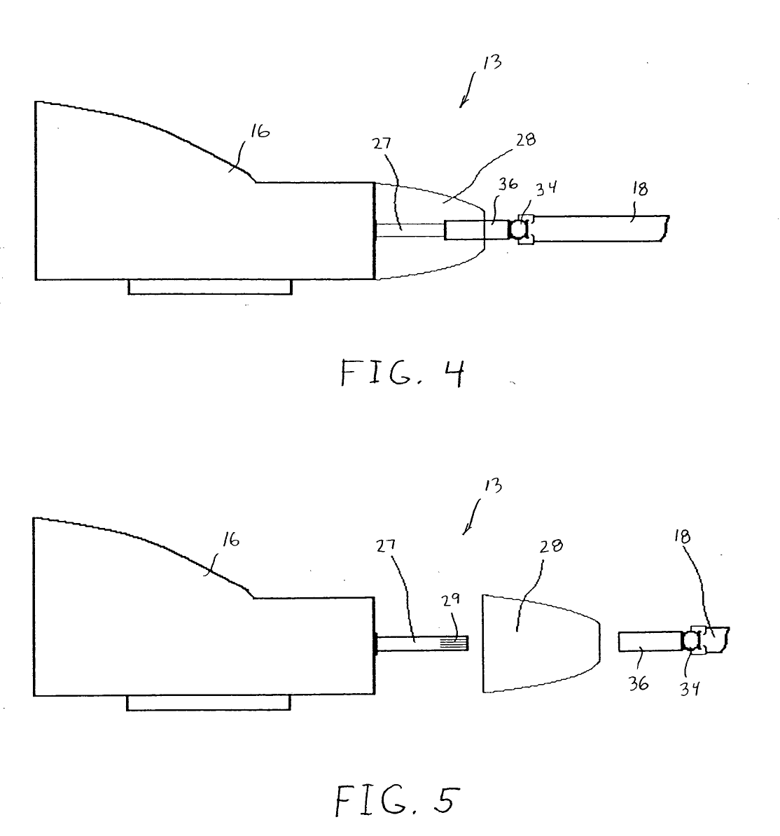

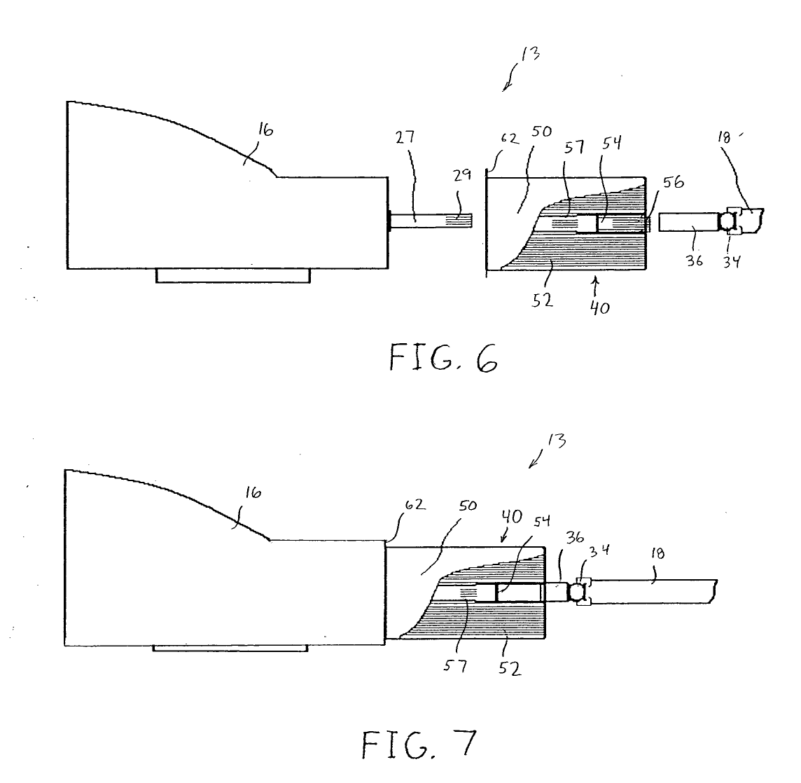

Referring now to FIG. 2, before being converted to a hybrid system, drive assembly 13 would include a transmission output shaft 27 and an output extension housing 28. The extension housing 28 is replaced when hybrid conversion kit 10 is installed on the vehicle as discussed in further detail below. Transmission output shaft 27 includes a splined end 29 for mounting drive shaft 18 to transmission output shaft 27. Splined end 29 is located at the end of output shaft 27 opposite the end that is attached to transmission 16. Output extension housing 28 includes a mounting flange 30 having mounting holes 32 for mounting the output extension housing 28 to transmission 16 with bolts or other fasteners (not shown). Also included in a typical drive assembly 13 are a universal joint 34 and a yolk 36 on the end of drive shaft 18 as shown in FIGS. 4-7.

Referring again to FIG. 1, hybrid conversion kit 10 includes a DC electric motor/generator assembly 40, a controller 42, and an electrical energy supply source 44. Motor/generator assembly 40 is mounted to the transmission on transmission output shaft 27 as shown in FIG. 3. Motor/generator assembly 40 includes a housing 50, an armature 52, and a connecting armature shaft 54 having a splined end 56 and a sleeve 57 having internal splines for making a driving connection with splined end 29 of transmission output shaft 27. Motor/generator assembly 40 also includes electrical wires 58 and a connector 59 for electrically connecting motor/generator assembly 40 to controller 42 and electrical energy supply source 44. Housing 50 includes an opening 60 at one end for allowing splined end 56 of connecting shaft 54 to be connected to drive shaft 18 and a flange 62 having mounting holes 64 so that motor/generator assembly 40 can be bolted to the same holes in transmission 16 to which output extension housing 28 is mounted prior to installing hybrid conversion kit 10. Housing 50 also includes an opening 66 adjacent flange 62 for receiving transmission output shaft 27. A number of high quality electric motors are presently available for use with existing hybrid vehicles and can readily be modified with the features of the motor/generator assembly 40. For example, Wavecrest offers a motor that may be very suitable for motor/generator assembly 40.

Controller 42 utilizes conventional components and circuitry as are known in the art. Through a wiring harness, the controller 42 may monitor signals such as the throttle position sensor, brake sensor and reverse gear light switch (not shown). Controller 42 preferably also monitors the battery's state of charge to adjust regenerative braking draw from the electrical motor/generator during deceleration. Controller 42 may also be connected to the alternator (not shown) of vehicle 12 to accept any additional charging current required and may use the alternator's current presence to monitor key-on and key-off status. Electrical energy supply source 44 may be a battery or battery array such as lithium ion polymer, nickel-chromium, lead acid or other suitable type. It is believed that lithium batteries may offer an advantage in that they tend to be more energy dense, lighter and operate at lower temperatures and typically do not produce fumes or gases. The batteries may be mounted anywhere on the vehicle where space permits as further described below.

Prior to installing hybrid conversion kit 10, a portion of drive assembly 13 of vehicle 12 will appear as shown in FIG. 4. In this view, transmission output shaft 27 is shown mounted to and extends from transmission 16 and is covered by output extension housing 28, which is bolted to transmission 16. Yoke 36 of drive shaft 18 is fitted on splined end 29 of the transmission output shaft for providing driving rotation of the driving shaft to drive the rear wheels. To install hybrid conversion kit 10, drive shaft 18 is removed from transmission output shaft 27, and output extension housing 28 is removed from transmission 16 as shown in FIG. 5.

Now referring to FIG. 6, to install hybrid conversion kit 10, DC motor/generator assembly 40 is placed ready for installation on transmission output shaft 27. DC motor/generator assembly 40 is then installed by inserting transmission output shaft 27 through opening 66 of housing 50 into sleeve 57 of connecting armature shaft 54 until motor/generator assembly abuts against transmission 16. In this manner, splined end 29 of transmission output shaft 27 will be drivingly engaged with the internal splines of sleeve 57 of connecting armature shaft 54. Housing 50 of motor/generator assembly 40 may be bolted to transmission 16 using mounting holes 64 and flange 62. Also, yoke 36 of drive shaft 18 is placed through opening 60 in housing 50 and around splined end 56 of connecting armature shaft 54. Yoke 36 is provided with internal splines to mate with the splines on end 56 for driving engagement of drive shaft 18.

The batteries or other energy storage device of electrical energy supply source 44 may be mounted in any convenient place in vehicle 12. For example, batteries may be installed in the C-channel frame of a truck, or the batteries for hybrid conversion kit 10 may also be used to replace the vehicle's main battery with a dual voltage battery. Controller 42 may also be mounted in any convenient and environmentally appropriate place in vehicle 12. Connector 59 is connected to controller 42 and electrical connecting wires (not shown) are also provided between controller 42 and battery/electrical energy supply source 44. As discussed above, electrical leads (not shown) may also be connected to the vehicle's alternator output, the throttle position sensor, the brake switch or a pressure transducer for proportional magnetic braking, and the reverse indicator circuit, (all of which are known and not shown).

When vehicle 12 is operating with hybrid conversion kit 10, during initial acceleration, controller 42 receives a signal from the throttle position sensor indicating input from the driver. Controller 42 proportionally delivers electrical current to electric motor/generator assembly 42 from electrical energy supply source 44 in accordance with the demand from the accelerator. This provides rotational torque that is applied to drive shaft 18, in addition to the torque supplied from engine 14, for propelling vehicle 12.

Once vehicle 12 has achieved an application specific preset speed, controller 42 suspends providing current to motor/generator assembly 40, which will free wheel at higher speeds. During deceleration of vehicle 12 as recognized through the throttle position sensor signal or brake application, controller 42 begins proportionally drawing current from electric motor/generator 40 as the armature is engaged and spun by transmission output shaft to charge electrical energy supply source/batteries 44. Additionally, the armature provides a magnetic braking effect while the motor/generator assembly 40 is generating current and aids in braking vehicle 12, which adds to the surface life of friction brakes 26a, 26b.

When vehicle 12 decelerates from higher speeds, the regenerative braking effect may be significantly more energy efficient than standard battery operated electric vehicles. Furthermore, electrical energy supply source 44 may also be charged by the vehicle's alternator. Conversely, the regenerative braking electrical energy may assist vehicle 12's engine driven alternator to charge the vehicle's regular battery.

This operational process repeats itself during every acceleration and deceleration cycle. Accordingly, it is believed that the benefits of a converted hybrid gas/electrical vehicle, may be operated at a fraction of the cost, while delivering benefits to the end user in a standard vehicle as a bolt on after market kit.

It should be appreciated that hybrid conversion kit 10 may be used with a multiplicity of vehicles. Rear-wheel drive trucks, vans, recreational vehicles, delivery trucks, postal trucks, route and surface vehicles have a drive assembly that lends itself for easily incorporating the hybrid conversion kit to take advantage of the benefits of the invention. In addition, front wheel drive and four wheel drive vehicles, including cars, SUVs and trucks, can be converted by placing an electric motor between the transmission output and the vehicle's wheels. For these types of vehicles, the mounting of an electric motor case/shaft design are modified for their particular components of the drive system. In addition, larger vehicles with two piece drive shafts can incorporate an electric motor/generator behind the transmission and between the transmission output shaft and the drive shaft support bearing. It is believed that only about 15-20 mounting variations are required to cover over 80% of the current light truck market.

While the invention has been taught with specific reference to the above described embodiments, one skilled in the art will recognize that changes can be made in form and detail without departing from the spirit and scope of the invention. As such, the described embodiments are to considered in all respects only as illustrative and not restrictive. Accordingly, the scope of the invention is not limited by the above description or drawings.

1. A hybrid electrical drive system for a vehicle, comprising a conversion kit for converting a vehicle with a standard internal combustion engine into a hybrid electrical vehicle, the conversion kit including generator means to intercept kinetic energy that would normally be wasted as the vehicle is decelerating or braking and convert the kinetic energy to electrical energy.

2. The electrical drive system of claim 1, wherein the generator means is profiled to fit intermediate a transmission and universal joint.

3. The electrical drive system of claim 1, wherein the generator means is comprised of a DC motor/generator.

4. The electrical drive system of claim 3, wherein the conversion kit further comprises an on board electrical energy supply for use in assisting with the acceleration of the vehicle, and the DC motor/generator recharges the on board electrical energy supply.
